(19) United States
(12) Patent Application Publication
(10) Pub. No.: US 2024/0232724 A9
(43) Pub. Date: Jul. 11, 2024

(54) AUTOMATICALLY PREDICTING DEVICE RECYCLING OPPORTUNITIES USING ARTIFICIAL INTELLIGENCE TECHNIQUES

(71) Applicant: Dell Products L.P., Round Rock, TX (US)

(72) Inventors: David J. Linsey, Marietta, GA (US); Bijan Kumar Mohanty, Austin, TX (US); Hung T. Dinh, Austin, TX (US)

(21) Appl. No.: 17/969,793

(22) Filed: Oct. 20, 2022

(51) Int. Cl. G06N 20/20

(52) U.S. Cl. CPC G06N 20/20

(57) ABSTRACT

Methods, apparatus, and processor-readable storage media for automatically predicting device recycling opportunities using artificial intelligence techniques are provided herein. An example computer-implemented method includes obtaining data associated with one or more devices; determining end of life-related information for the one or more devices by processing at least a portion of the obtained data; predicting at least one device recycling opportunity for at least one of the one or more devices by processing at least a portion of the determined end of life-related information using one or more artificial intelligence techniques; and performing one or more automated actions based at least in part on the at least one predicted device recycling opportunity.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to techniques for managing resources using such systems.

### BACKGROUND

Global electronic waste is increasing, with only a limited amount of such electronic waste being recycled. Hardware products may be decommissioned in various ways (e.g., wholesale replacement of an entire product, upgrading or replacing certain parts within a product, decommissioning of a product with no replacement, etc.). Once this happens, users often discard the decommissioned product.

Due to natural lags within product replacement or upgrade processes, users may forget about or ignore available recycling processes. Accordingly, conventional resource management approaches are typically limited to providing manual reactive notifications to users upon receiving indications of device decommissioning, resulting in increased electronic waste as well as resource-intensive actions related thereto.

### SUMMARY

Illustrative embodiments of the disclosure provide techniques for automatically predicting device recycling opportunities using artificial intelligence techniques. An exemplary computer-implemented method includes obtaining data associated with one or more devices, and determining end of life-related information for the one or more devices by processing at least a portion of the obtained data. The method also includes predicting at least one device recycling opportunity for at least one of the one or more devices by processing at least a portion of the determined end of life-related information using one or more artificial intelligence techniques. Further, the method additionally includes performing one or more automated actions based at least in part on the at least one predicted device recycling opportunity.

Illustrative embodiments can provide significant advantages relative to conventional resource management approaches. For example, problems associated with increased electronic waste are overcome in one or more embodiments through automatically predicting device recycling opportunities using artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automatically predicting device recycling opportunities using artificial intelligence techniques in an illustrative embodiment.

FIG. 2 shows example system architecture in an illustrative embodiment.

FIG. 3 shows example pseudocode for data preprocessing in an illustrative embodiment.

FIG. 4 shows example pseudocode for temporal feature engineering in an illustrative embodiment.

FIG. 5 shows example pseudocode for encoding categorical values into numerical values in an illustrative embodiment.

FIG. 6 shows example pseudocode for splitting a dataset into training and testing sets in an illustrative embodiment.

FIG. 7 shows example pseudocode for creating a gradient boosting classifier in an illustrative embodiment.

FIG. 8 shows example pseudocode for predicting end of life for devices in an illustrative embodiment.

FIG. 9 shows example pseudocode for implementing an extreme gradient boosting classifier in an illustrative embodiment.

FIG. 10 shows example pseudocode for predicting end of life for devices using an extreme gradient boosting classifier in an illustrative embodiment.

FIG. 11 is a flow diagram of a process for automatically predicting device recycling opportunities using artificial intelligence techniques in an illustrative embodiment.

FIGS. 12 and 13 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

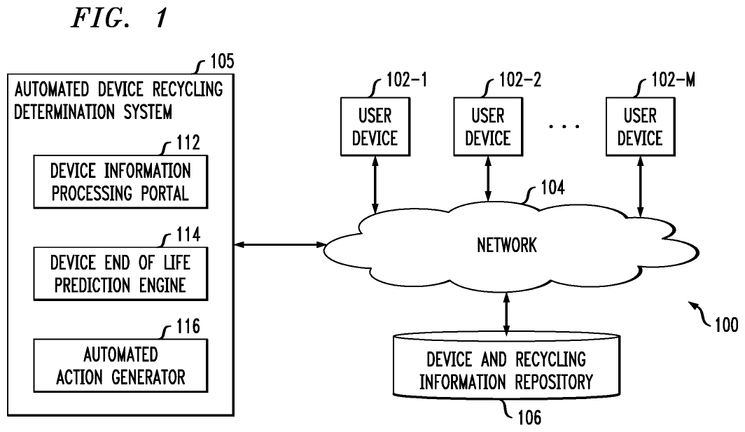

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated device recycling determination system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, automated device recycling determination system 105 can have at least one associated device and recycling information repository 106 configured to store data pertaining to device-related and recycling operations, which comprise, for example, device health parameters, device usage information, recycling support-related information, temporal-based recycling information etc.

The at least one device and recycling information repository 106 in the present embodiment is implemented using one or more storage systems associated with automated device recycling determination system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with automated device recycling determination system 105 are one or more input-output devices, which illustratively comprise keyboards, displays or other types of input-output devices in any combination. Such input-output devices can be used, for example, to support one or more user interfaces to automated device recycling determination system 105, as well as to support communication between automated device recycling determination system 105 and other related systems and devices not explicitly shown.

Additionally, automated device recycling determination system 105 in the FIG. 1 embodiment is assumed to be implemented using at least one processing device. Each such processing device generally comprises at least one processor and an associated memory, and implements one or more functional modules for controlling certain features of automated device recycling determination system 105.

More particularly, automated device recycling determination system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows automated device recycling determination system 105 to communicate over the network 104 with the user devices 102, and illustratively comprises one or more conventional transceivers.

The automated device recycling determination system 105 further comprises device information processing portal 112, device end of life prediction engine 114, and automated action generator 116.

It is to be appreciated that this particular arrangement of elements 112, 114 and 116 illustrated in the automated device recycling determination system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for automatically predicting device recycling opportunities using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, automated device recycling determination system 105 and at least one device and recycling information repository 106 can be on and/or part of the same processing platform.

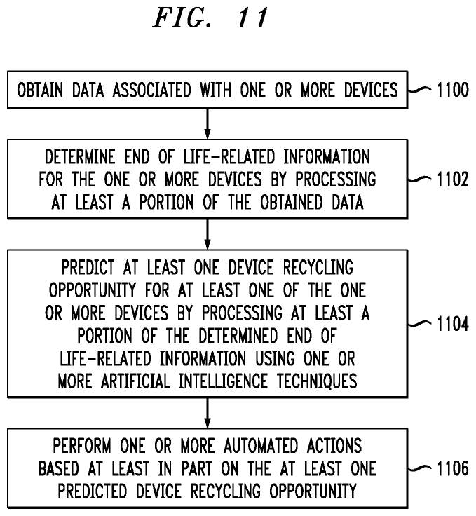

An exemplary process utilizing elements 112, 114 and 116 of an example automated device recycling determination system 105 in computer network 100 will be described in more detail with reference to the flow diagram of FIG. 11.

Accordingly, at least one embodiment includes automatically predicting device recycling opportunities using artificial intelligence techniques. As detailed herein, such an embodiment includes leveraging artificial intelligence techniques to predict whether one or more devices have met or exceeded a corresponding lifespan and are ready for recycling. Such artificial intelligence techniques can include at least one machine learning classification algorithm which uses historical device information (e.g., telemetry data), device-related support information, and recycling-related information to train the corresponding model to predict the class of recycling status (e.g., yes or no) for a given device. Such an embodiment accordingly includes implementing a predictive recycling process to preemptively facilitate users making environmentally friendly recycling decisions, thus increasing and/or improving sustainability efforts.

One or more embodiments include monitoring and/or determining indicators which can be used to capture awareness of decommissioning of devices due to happen in the future and/or overdue for happening. By identifying and leveraging such indicators through a predictive process, and by leveraging existing information known about the user, at least one embodiment can include provide time-appropriate notifications and/or recommendations on how to recycle one or more devices.

One example indicator includes upgrade purchases, wherein some devices, such as computers, servers, storage, etc., are upgradable with one or more additional parts and/or components (e.g., hard drives, memory, processors, power supplies, nodes, etc.). Another example indicator includes user replaceable purchases, wherein, like upgrade purchases, some users may elect to perform their own on-site repairs and/or replacements should issues arise. Yet another example indicator includes specific service purchases, wherein certain services, when purchased, correspond to a given likelihood of electronic waste being produced. For example, data migration services can indicate a particular product may be getting replaced, even if the replacement is not purchased at the same time or from the same entity. In a similar manner, specific deployment and/or installation services can indicate a change on a user's site which could result in electronic waste.

Another example indicator includes telemetry information from smart devices, which can be an indicator that there may be one or more decommissioned devices or components thereof. Telemetry information, for example, can implicitly (e.g., via deltas) show removal of one or more products and/or can explicatively communicate de-installation of one or more products. For example, removal of a hard drive and/or addition of a new hard drive can show up in telemetry information. Alternately, should a complete product be decommissioned, it will cease to communicate and/or generate telemetry information, and after a defined quiet period, it is possible to reliably determine that this product may no longer be operational or installed. Yet another example indicator includes scheduled targeted notifications. For example, a system that is not actively being used and/or is offline and forgotten can be identified and the subject of a recycling recommendation to a user.

In connection with the above-noted example indicators, one or more embodiments includes intelligently predicting the end of life of the corresponding device such that only those devices are proposed and/or identified for recycling.

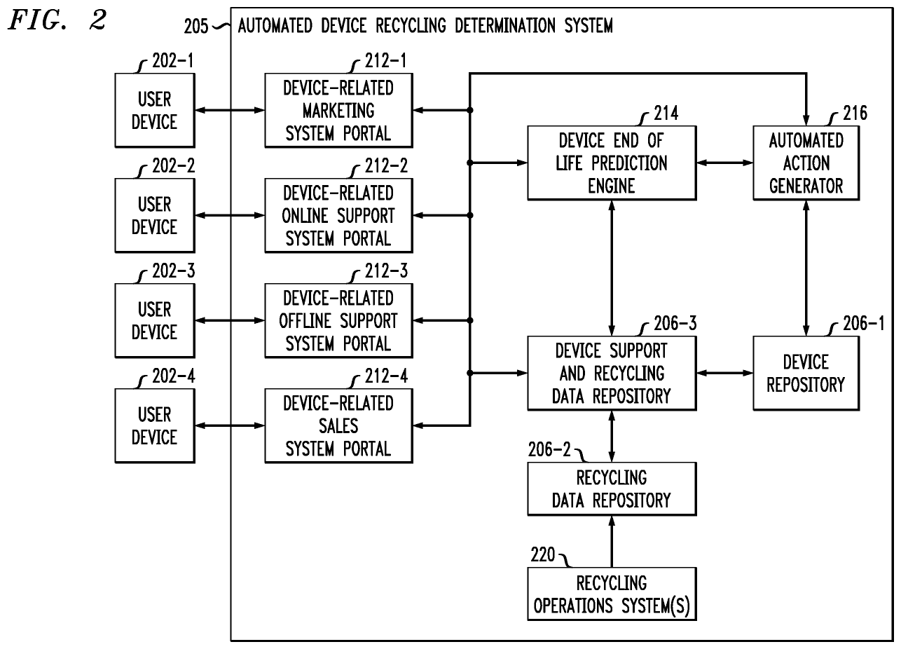

FIG. 2 shows example system architecture in an illustrative embodiment. By way of illustration, FIG. 2 depicts user devices 202-1, 202-2, 202-3 and 202-4, as well as automated device recycling determination system 205. Within automated device recycling determination system 205, various device information processing portals are implemented, including device-related marketing system portal 212-1, device-related online support system portal 212-2, device-related offline support system portal 212-3, and device-related sales system portal 212-4, which process information pertaining to devices from users (e.g., user devices 202-1, 202-2, 202-3 and 202-4, respectively) and one or more additional systems and/or repositories, as further detailed herein.

Additionally, automated device recycling determination system 205 includes device end of life prediction engine 214, which uses one or more machine learning algorithms to build at least one classifier trained using data from device support and recycling data repository 206-3, which can include historical device information and support details from device repository 206-1, and the data pertaining to recycled devices and recycling operations from recycling data repository 206-2. Accordingly, and as described herein, device end of life prediction engine 214 can be trained to predict whether a given device has reached or will soon reach end of life.

Training data such as noted above can be obtained from multiple sources and/or systems of records. Such sources and/or systems of records can include, for example, one or more asset management databases (AMDBs) and/or one or more configuration management databases (CMDBs), which contain information pertaining to devices and associated information such as user information, configuration information, date of acquisition, etc. Similarly, such sources and/or systems of records can include support systems such as one or more customer relationship management (CRM) databases, which contain historical case and/or incident data as well as telemetry information of devices. Additionally, information pertaining to devices that are recycled can be stored in one or more recycling systems of records.

As depicted in FIG. 2, for example, in one or more embodiments, information from such sources and/or systems of records can be obtained, engineered, and stored in device support and recycling data repository 206-3, which stores the data used for training the model associated with device end of life prediction engine 214.

As such, device end of life prediction engine 214 uses at least one machine learning model to predict end of life-related information for a given device by processing information including, for example, type and model of the device, configuration of the device, and/or one or more other device-related features. As also depicted in FIG. 2, end of life prediction engine 214 provides at least one output (e.g., an end of life prediction for a given device) to automated action generator 216, which, based at least in part on the output(s) provided by end of life prediction engine 214, initiates and/or performs one or more automated actions (e.g., one or more recycling-related automated actions). For example, automated action generator 216 can generate and output at least one notification (e.g., via one or more of portals 212-1, 212-2, 212-3 and 212-4) to a corresponding user (e.g., via one of user devices 202), wherein such a notification can identify a given device as recommended for recycling. As also depicted in FIG. 2, recycling operations system(s) 220 includes at least one asset recovery and recycling application that initiates recycling dispatches to one or more eco-partners and processes settlement details from such partners after recycling tasks are carried out.

In at least one embodiment, end of life prediction engine 214 includes using gradient boosting, an ensemble boosting algorithm that utilizes a multitude of weak decision tree-based models to build a model with enhanced prediction accuracy. As an ensemble approach, gradient boosting uses a group of weak models, and as a boosting approach, gradient boosting iteratively learns from each weak model to build a single strong (er) model. Further, gradient boosting is a sequential approach of learning and building the model, capable of various types of machine learning activities including regression, classification, ranking, and/or recommendation. Additionally, gradient boosting is an iterative functional gradient algorithm, which minimizes a loss function by iteratively choosing a function that points towards the negative gradient.

In at least one gradient boosting algorithm, each predictor (e.g., device end of life) attempts to improve on its predecessor by reducing the error. However, instead of fitting the predictor on the data on each iteration, the gradient boosting algorithm fits a new predictor to the residual errors made by the previous predictor. Example steps of such an algorithm are detailed below.

To make an initial prediction on data, the algorithm processes the log of the odds of the target variable (e.g., device end of life). This can be the number of YES values (1 after encoding) divided by the number of NO values (0 after encoding). For example, in a dataset of 200,000 devices, if 120,000 devices have an end of life value marked as YES and 80,000 devices having an end of life value marked as NO, then the log(odd)=log(120000/80000). This is the base estimator which will be used for the initial prediction.

The log(odd) is converted into a probability value by using a logistic function to make one or more predictions. The formula to convert the log(odd) to a probability value (e.g., the formula that a gradient boosting classifier can use to predict whether a device is recyclable) can be given as Equation (1) as follows:

e*log(odds)/(1+e*log(odds)) (1)

wherein e represents Euler's number, a mathematical constant of value of approximately 2.71828. For every observation of the training set, the algorithm calculates the error or residual for that observation or instance, which can include the difference between the observed value and the predicted value. Once the residuals are calculated, a new decision tree is built that attempts to predict the errors or residuals previously calculated. For a gradient boosting algorithm for classification, the formula for transformation can be given as Equation (2) as follows:

$$\frac{\sum Residual}{\sum ( Previous Probability , \times ( 1 - Previous Probability ) )} \qquad ( 2 )$$

wherein Σ indicates the sum of and “Previous Probability” refers to the previously calculated probability computed in connection with Equation (1).

In one or more embodiments, the gradient boosting algorithm generates one or more new and/or additional predictions by first getting a log(odd) prediction for each observation/instance in the training set and converting that prediction into a probability. The formula for making such a prediction (e.g., as performed in connection with a gradient boosting classifier) can be given as Equation (3) as follows.

base_log_odds+(learnin_rate*predicted residual value) (3)

wherein the learning_rate is a model hyperparameter which can be tuned to scale each tree's contribution sacrificing bias for improved variance. In connection with each observation in the training data, the log(odd) prediction of the observation is calculated, which is then converted into a probability. The base_log_odds represents that probability value.

Also, as detailed herein, one or more embodiments include leveraging at least one extreme gradient boosting algorithm, which is an extension algorithm to the gradient boosting algorithm.

In one or more embodiments, implementation of a device end of life prediction engine can be achieved, for example, using Python language, as well as Pandas, Numpy and SciKitLearn libraries.

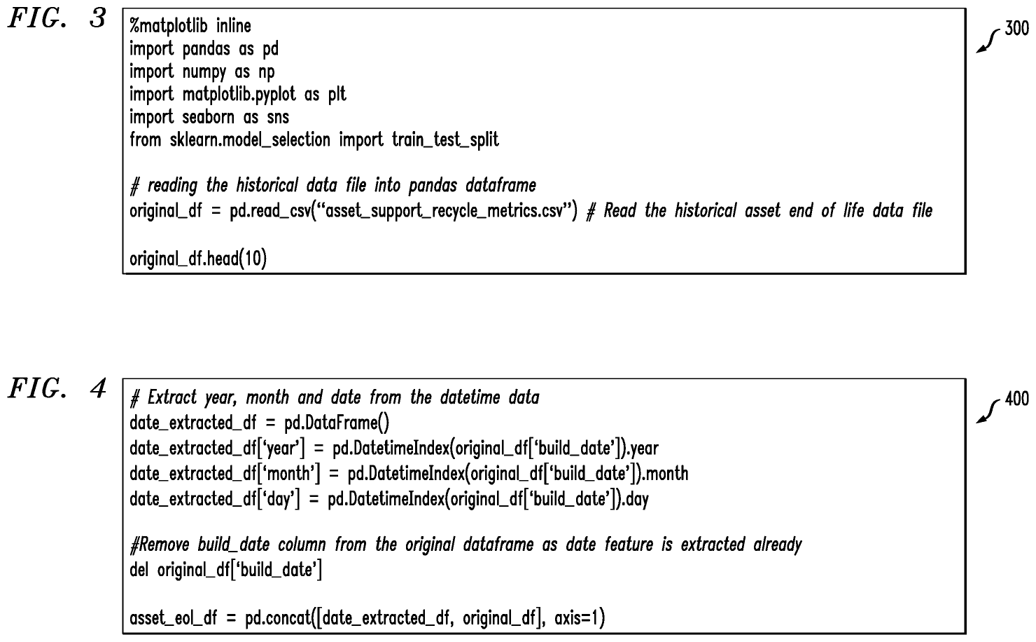

FIG. 3 shows example pseudocode for data preprocessing in an illustrative embodiment. In this embodiment, example pseudocode 300 is executed by or under the control of at least one processing system and/or device. For example, the example pseudocode 300 may be viewed as comprising a portion of a software implementation of at least part of automated device recycling determination system 105 of the FIG. 1 embodiment.

The example pseudocode 300 illustrates importing multiple libraries and reading a historical data file to create a Pandas data frame. The data frame can contain columns including the independent variables and a column including the dependent/target variable (e.g., device end of life). Also, in one or more embodiments, preprocessing of such data can include handling any null or missing values in the columns. For example, null or missing values in numerical columns can be replaced by the median value of that column. Additionally, after performing initial data analysis by creating univariate and/or bivariate plots of the columns, the importance and/or influence of each column can be determined and/or understood. Further, columns that have no role or influence on the actual prediction (e.g., target variable) can be removed.

It is to be appreciated that this particular example pseudocode shows just one example implementation of data preprocessing, and alternative implementations of the process can be used in other embodiments.

FIG. 4 shows example pseudocode for temporal feature engineering in an illustrative embodiment. In this embodiment, example pseudocode 400 is executed by or under the control of at least one processing system and/or device. For example, the example pseudocode 400 may be viewed as comprising a portion of a software implementation of at least part of automated device recycling determination system 105 of the FIG. 1 embodiment.

The example pseudocode 400 illustrates extracting build_date, a date-time object, in connection with a feature engineering step to create year, month and date columns. Accordingly, pseudocode 400 illustrates feature engineering of build_date to create a new data frame with extracted features and one or more already existing features.

It is to be appreciated that this particular example pseudocode shows just one example implementation of temporal feature engineering, and alternative implementations of the process can be used in other embodiments.

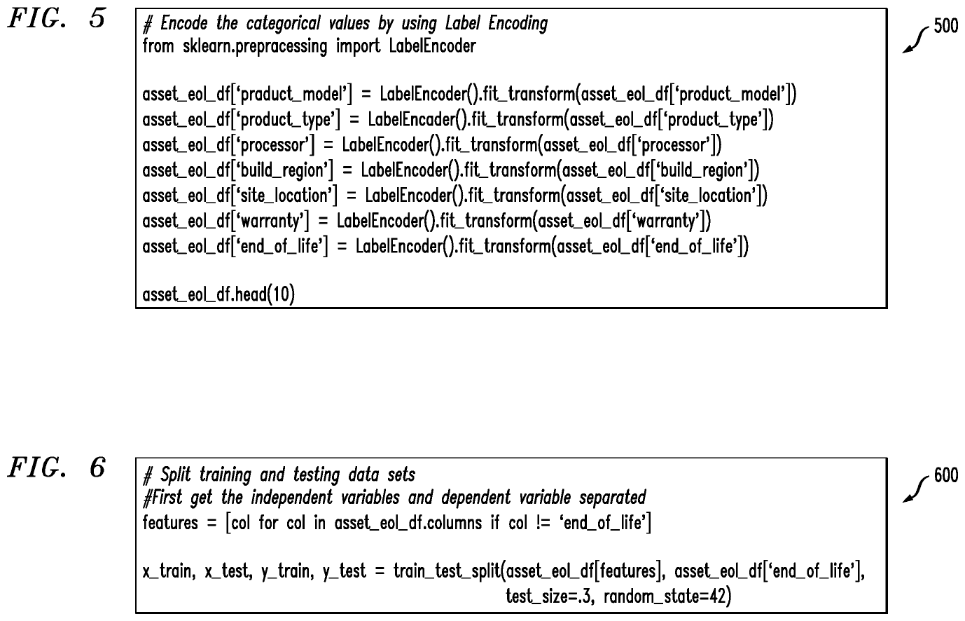

FIG. 5 shows example pseudocode for encoding categorical values into numerical values in an illustrative embodiment. In this embodiment, example pseudocode 500 is executed by or under the control of at least one processing system and/or device. For example, the example pseudocode 500 may be viewed as comprising a portion of a software implementation of at least part of automated device recycling determination system 105 of the FIG. 1 embodiment.

The example pseudocode 500 illustrates encoding the categorical and/or textual values into encoded numeric form on which the machine learning algorithm can operate. Such encoding can be achieved using a LabelEncoder function of a SciKitLearn library.

It is to be appreciated that this particular example pseudocode shows just one example implementation of encoding categorical values into numerical values, and alternative implementations of the process can be used in other embodiments.

FIG. 6 shows example pseudocode for splitting a dataset into training and testing sets in an illustrative embodiment. In this embodiment, example pseudocode 600 is executed by or under the control of at least one processing system and/or device. For example, the example pseudocode 600 may be viewed as comprising a portion of a software implementation of at least part of automated device recycling determination system 105 of the FIG. 1 embodiment.

The example pseudocode 600 illustrates splitting the dataset into training and testing sets by using a train test split function of a SciKitLearn library. By way of example, 70% of the dataset can split into training data and 30% can be stored for testing data. By way of further example, one or more embodiments can include creating four total sets, including two training sets for the independent/X variable and the dependent/Y variables, and similarly two sets for testing.

It is to be appreciated that this particular example pseudocode shows just one example implementation of splitting a dataset into training and testing sets, and alternative implementations of the process can be used in other embodiments.

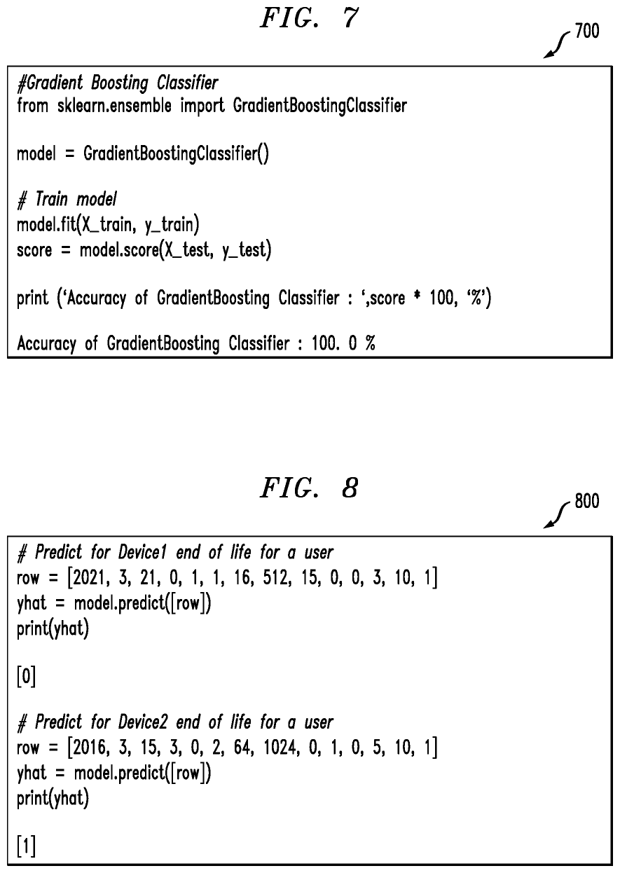

FIG. 7 shows example pseudocode for creating a gradient boosting classifier in an illustrative embodiment. In this embodiment, example pseudocode 700 is executed by or under the control of at least one processing system and/or device. For example, the example pseudocode 700 may be viewed as comprising a portion of a software implementation of at least part of automated device recycling determination system 105 of the FIG. 1 embodiment.

The example pseudocode 700 illustrates creating a gradient boosting classifier model using one or more algorithms of a SciKitLearn library, training the model, and evaluating the accuracy of the model.

It is to be appreciated that this particular example pseudocode shows just one example implementation of creating a gradient boosting classifier, and alternative implementations of the process can be used in other embodiments.

FIG. 8 shows example pseudocode for predicting end of life for devices in an illustrative embodiment. In this embodiment, example pseudocode 800 is executed by or under the control of at least one processing system and/or device. For example, the example pseudocode 800 may be viewed as comprising a portion of a software implementation of at least part of automated device recycling determination system 105 of the FIG. 1 embodiment.

The example pseudocode 800 illustrates predicting, using a gradient boosting classifier model, end of life of two different devices with different values in their features. A final value of 0 (as seen for Device1) indicates a NO, meaning that end of life has not been reached, and a final value of 1 (as seen for Device2) indicates YES, meaning that end of life has been reached and the device is ready to be recycled.

It is to be appreciated that this particular example pseudocode shows just one example implementation of predicting end of life for devices, and alternative implementations of the process can be used in other embodiments.

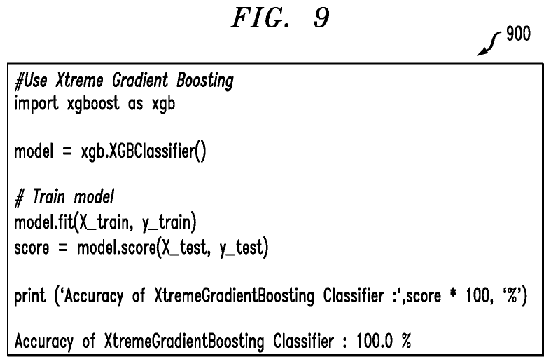

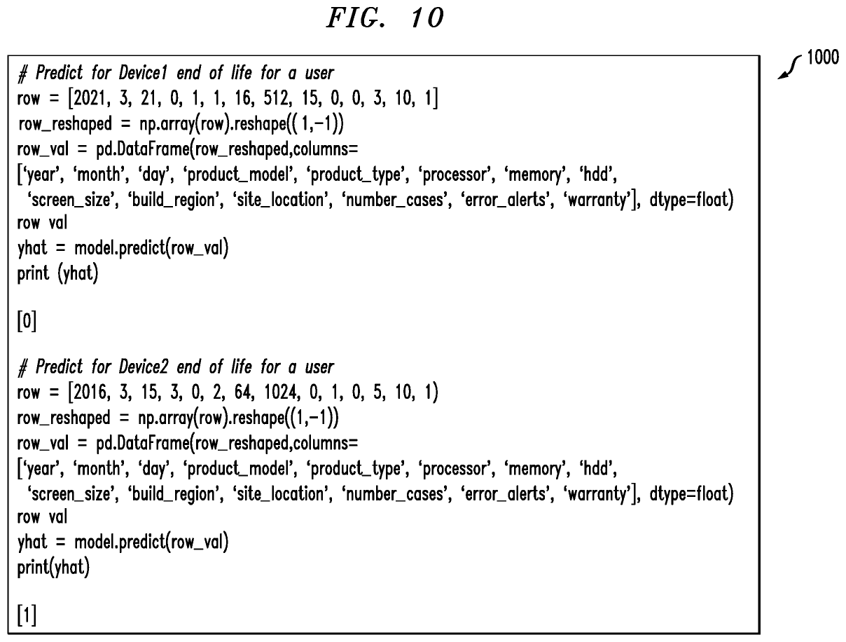

FIG. 9 shows example pseudocode for implementing an extreme gradient boosting classifier in an illustrative embodiment. In this embodiment, example pseudocode 900 is executed by or under the control of at least one processing system and/or device. For example, the example pseudocode 900 may be viewed as comprising a portion of a software implementation of at least part of automated device recycling determination system 105 of the FIG. 1 embodiment.

The example pseudocode 900 illustrates improving the model performance by using an extreme gradient boosting classifier, which is installed using the following command in the python console: pip install xgboost. An xgboost library is imported, the model is created using the XGBClassifier( ) of the library, and the accuracy is measured.

It is to be appreciated that this particular example pseudocode shows just one example implementation of an extreme gradient boosting classifier, and alternative implementations of the process can be used in other embodiments.

FIG. 10 shows example pseudocode for predicting end of life for devices using an extreme gradient boosting classifier in an illustrative embodiment. In this embodiment, example pseudocode 1000 is executed by or under the control of at least one processing system and/or device. For example, the example pseudocode 1000 may be viewed as comprising a portion of a software implementation of at least part of automated device recycling determination system 105 of the FIG. 1 embodiment.

The example pseudocode 1000 illustrates using information pertaining to the same two devices as detailed in pseudocode 800, the end of life of both devices are predicted by using the extreme gradient boosting classifier.

It is to be appreciated that this particular example pseudocode shows just one example implementation of predicting end of life for devices using an extreme gradient boosting classifier, and alternative implementations of the process can be used in other embodiments.

Once the predictive recycling process awareness is triggered in connection with a device, one or more embodiments can include intelligently notifying one or more contacts associated with the device (e.g., a contact who can act on the recycling notification). Additionally, at least one embodiment can include configuring contacts in an exclusionary and/or additive manner along with one or more corresponding notification-related priorities. By way of example, for large customers with many products, a configurable windowing threshold can be implemented such that the notifications are only transmitted for a given rolling window (e.g., the last week of a device's useful life, the last month of a device's useful life, etc.).

Notification content can also vary from implementation to implementation and user to user, and can contain, for example, information and/or links pertaining to how to initiate recycling (e.g., such as finding local recyclers, how to initiate a pickup and/or shipment, etc.), information pertaining to proactively pushing electronic waybills.

Also, an automated action generator (e.g., element 116 in FIG. 1) can generate appropriate notifications with respect to devices ready for recycling (e.g., devices that have reached or will soon reach end of life) and output such notifications to corresponding users. In one or more embodiments, such a notification can also automatically initiate one or more actions by at least one additional system (e.g., recycling-related actions). Additionally or alternatively, at least one embodiment can include reducing and/or preventing sending duplicate notifications for the same device to the same user by hashing information pertaining to the user and device(s) (e.g., using tags) once the notification has been sent, and caching the hash for subsequent verification of whether a notification has been previously sent or not.

It is to be appreciated that a “model,” as used herein, refers to an electronic digitally stored set of executable instructions and data values, associated with one another, which are capable of receiving and responding to a programmatic or other digital call, invocation, and/or request for resolution based upon specified input values, to yield one or more output values that can serve as the basis of computer-implemented recommendations, output data displays, machine control, etc. Persons of skill in the field may find it convenient to express models using mathematical equations, but that form of expression does not confine the model(s) disclosed herein to abstract concepts; instead, each model herein has a practical application in a processing device in the form of stored executable instructions and data that implement the model using the processing device.

FIG. 11 is a flow diagram of a process for automatically predicting device recycling opportunities using artificial intelligence techniques in an illustrative embodiment. It is to be understood that this particular process is only an example, and additional or alternative processes can be carried out in other embodiments.

In this embodiment, the process includes steps 1100 through 1106. These steps are assumed to be performed by the automated device recycling determination system 105 utilizing elements 112, 114 and 116.

Step 1100 includes obtaining data associated with one or more devices. In at least one embodiment, obtaining data associated with one or more devices includes obtaining one or more of telemetry data, configuration data, user-related data, and temporal-related data.

Step 1102 includes determining end of life-related information for the one or more devices by processing at least a portion of the obtained data. In one or more embodiments, determining end of life-related information for the one or more devices includes identifying at least one of the one or more devices that has exceeded a predetermined end of life status. Additionally or alternatively, determining end of life-related information for the one or more devices can include identifying at least one of the one or more devices that is within a given threshold value of a predetermined end of life status.

Step 1104 includes predicting at least one device recycling opportunity for at least one of the one or more devices by processing at least a portion of the determined end of life-related information using one or more artificial intelligence techniques. In at least one embodiment, predicting at least one device recycling opportunity includes processing at least a portion of the determined end of life-related information using at least one gradient boosting classifier model comprising multiple decision tree-based models. In such an embodiment, processing at least a portion of the determined end of life-related information using at least one gradient boosting classifier model can include implementing at least one extreme gradient boosting algorithm as an extension to the at least one gradient boosting classifier model.

Step 1106 includes performing one or more automated actions based at least in part on the at least one predicted device recycling opportunity. In one or more embodiments, performing one or more automated actions includes automatically generating and outputting at least one notification, in accordance with the at least one predicted device recycling opportunity, to at least one user associated with the at least one device. In at least one embodiment, performing one or more automated actions includes automatically initiating, in accordance with the at least one predicted device recycling opportunity, one or more device recycling-related actions in connection with one or more systems (e.g., generating and/or providing recycling-related materials, etc.). Additionally or alternatively, performing one or more automated actions can include automatically training the one or more artificial intelligence techniques using feedback related to the at least one predicted device recycling opportunity.

Also, in connection with the techniques depicted in FIG. 11, the one or more artificial intelligence techniques can be trained using historical device information, device-related support information, and recycling-related information.

Accordingly, the particular processing operations and other functionality described in conjunction with the flow diagram of FIG. 11 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically predict device recycling opportunities using artificial intelligence techniques. These and other embodiments can effectively overcome problems with convention approaches resulting in increased electronic waste.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

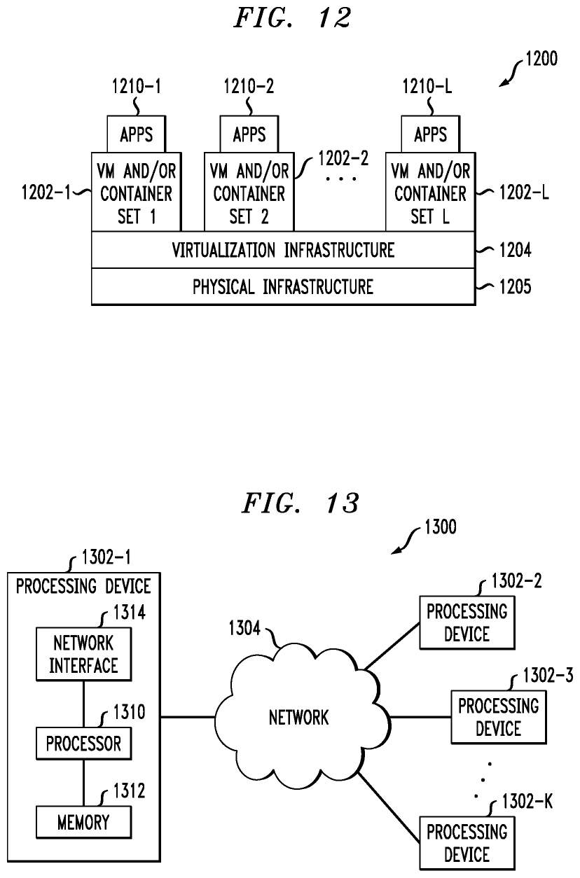

Illustrative embodiments of processing platforms will now be described in greater detail with reference to FIGS. 12 and 13. Although described in the context of system 100, these platforms may also be used to implement at least portions of other information processing systems in other embodiments.

FIG. 12 shows an example processing platform comprising cloud infrastructure 1200. The cloud infrastructure 1200 comprises a combination of physical and virtual processing resources that are utilized to implement at least a portion of the information processing system 100. The cloud infrastructure 1200 comprises multiple virtual machines (VMs) and/or container sets 1202-1, 1202-2, . . . 1202-L implemented using virtualization infrastructure 1204. The virtualization infrastructure 1204 runs on physical infrastructure 1205, and illustratively comprises one or more hypervisors and/or operating system level virtualization infrastructure. The operating system level virtualization infrastructure illustratively comprises kernel control groups of a Linux operating system or other type of operating system.

The cloud infrastructure 1200 further comprises sets of applications 1210-1, 1210-2, . . . 1210-L running on respective ones of the VMs/container sets 1202-1, 1202-2, . . . 1202-L under the control of the virtualization infrastructure 1204. The VMs/container sets 1202 comprise respective VMs, respective sets of one or more containers, or respective sets of one or more containers running in VMs. In some implementations of the FIG. 12 embodiment, the VMs/container sets 1202 comprise respective VMs implemented using virtualization infrastructure 1204 that comprises at least one hypervisor.

A hypervisor platform may be used to implement a hypervisor within the virtualization infrastructure 1204, wherein the hypervisor platform has an associated virtual infrastructure management system. The underlying physical machines comprise one or more information processing platforms that include one or more storage systems.

In other implementations of the FIG. 12 embodiment, the VMs/container sets 1202 comprise respective containers implemented using virtualization infrastructure 1204 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1200 shown in FIG. 12 may represent at least a portion of one processing platform. Another example of such a processing platform is processing platform 1300 shown in FIG. 13.

The processing platform 1300 in this embodiment comprises a portion of system 100 and includes a plurality of processing devices, denoted 1302-1, 1302-2, 1302-3, . . . 1302-K, which communicate with one another over a network 1304.

The network 1304 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1302-1 in the processing platform 1300 comprises a processor 1310 coupled to a memory 1312.

The processor 1310 comprises a microprocessor, a CPU, a GPU, a TPU, a microcontroller, an ASIC, a FPGA or other type of processing circuitry, as well as portions or combinations of such circuitry elements.

The memory 1312 comprises random access memory (RAM), read-only memory (ROM) or other types of memory, in any combination. The memory 1312 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1302-1 is network interface circuitry 1314, which is used to interface the processing device with the network 1304 and other system components, and may comprise conventional transceivers.

The other processing devices 1302 of the processing platform 1300 are assumed to be configured in a manner similar to that shown for processing device 1302-1 in the figure.

Again, the particular processing platform 1300 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining data associated with one or more devices;
determining end of life-related information for the one or more devices by processing at least a portion of the obtained data;
predicting at least one device recycling opportunity for at least one of the one or more devices by processing at least a portion of the determined end of life-related information using one or more artificial intelligence techniques; and
performing one or more automated actions based at least in part on the at least one predicted device recycling opportunity;
wherein the method is performed by at least one processing device comprising a processor coupled to a memory.

2. The computer-implemented method of claim 1, wherein predicting at least one device recycling opportunity comprises processing at least a portion of the determined end of life-related information using at least one gradient boosting classifier model comprising multiple decision tree-based models.

3. The computer-implemented method of claim 2, wherein processing at least a portion of the determined end of life-related information using at least one gradient boosting classifier model comprises implementing at least one extreme gradient boosting algorithm as an extension to the at least one gradient boosting classifier model.

4. The computer-implemented method of claim 1, wherein determining end of life-related information for the one or more devices comprises identifying at least one of the one or more devices that has exceeded a predetermined end of life status.

5. The computer-implemented method of claim 1, wherein determining end of life-related information for the one or more devices comprises identifying at least one of the one or more devices that is within a given threshold value of a predetermined end of life status.

6. The computer-implemented method of claim 1, wherein obtaining data associated with one or more devices comprises obtaining one or more of telemetry data, configuration data, user-related data, and temporal-related data.

7. The computer-implemented method of claim 1, wherein performing one or more automated actions comprises automatically generating and outputting at least one notification, in accordance with the at least one predicted device recycling opportunity, to at least one user associated with the at least one device.

8. The computer-implemented method of claim 1, wherein performing one or more automated actions comprises automatically initiating, in accordance with the at least one predicted device recycling opportunity, one or more device recycling-related actions in connection with one or more systems.

9. The computer-implemented method of claim 1, wherein performing one or more automated actions comprises automatically training the one or more artificial intelligence techniques using feedback related to the at least one predicted device recycling opportunity.

10. The computer-implemented method of claim 1, wherein the one or more artificial intelligence techniques are trained using historical device information, device-related support information, and recycling-related information.

11. A non-transitory processor-readable storage medium having stored therein program code of one or more software programs, wherein the program code when executed by at least one processing device causes the at least one processing device:
to obtain data associated with one or more devices;
to determine end of life-related information for the one or more devices by processing at least a portion of the obtained data;
to predict at least one device recycling opportunity for at least one of the one or more devices by processing at least a portion of the determined end of life-related information using one or more artificial intelligence techniques; and
to perform one or more automated actions based at least in part on the at least one predicted device recycling opportunity.

12. The non-transitory processor-readable storage medium of claim 11, wherein predicting at least one device recycling opportunity comprises processing at least a portion of the determined end of life-related information using at least one gradient boosting classifier model comprising multiple decision tree-based models.

13. The non-transitory processor-readable storage medium of claim 11, wherein performing one or more automated actions comprises automatically generating and outputting at least one notification, in accordance with the at least one predicted device recycling opportunity, to at least one user associated with the at least one device.

14. The non-transitory processor-readable storage medium of claim 11, wherein performing one or more automated actions comprises automatically initiating, in accordance with the at least one predicted device recycling opportunity, one or more device recycling-related actions in connection with one or more systems.

15. The non-transitory processor-readable storage medium of claim 11, wherein performing one or more automated actions comprises automatically training the one or more artificial intelligence techniques using feedback related to the at least one predicted device recycling opportunity.

16. An apparatus comprising:
at least one processing device comprising a processor coupled to a memory;
the at least one processing device being configured:
to obtain data associated with one or more devices;
to determine end of life-related information for the one or more devices by processing at least a portion of the obtained data;
to predict at least one device recycling opportunity for at least one of the one or more devices by processing at least a portion of the determined end of life-related information using one or more artificial intelligence techniques; and
to perform one or more automated actions based at least in part on the at least one predicted device recycling opportunity.

17. The apparatus of claim 16, wherein predicting at least one device recycling opportunity comprises processing at least a portion of the determined end of life-related information using at least one gradient boosting classifier model comprising multiple decision tree-based models.

18. The apparatus of claim 16, wherein performing one or more automated actions comprises automatically generating and outputting at least one notification, in accordance with the at least one predicted device recycling opportunity, to at least one user associated with the at least one device.

19. The apparatus of claim 16, wherein performing one or more automated actions comprises automatically initiating, in accordance with the at least one predicted device recycling opportunity, one or more device recycling-related actions in connection with one or more systems.

20. The apparatus of claim 16, wherein performing one or more automated actions comprises automatically training the one or more artificial intelligence techniques using feedback related to the at least one predicted device recycling opportunity.
